(19) United States
(12) Patent Application Publication
(10) Pub. No.: US 2015/0238935 A1
(43) Pub. Date: Aug. 27, 2015

(54) METHOD FOR SYNTHESIZING SILVER NANOPARTICLES ON TiO2 USING HYBRID POLYMERS

(71) Applicant: UMM AL-QURA UNIVERSITY, Makkah (SA)

(72) Inventors: Mohamed Mokhtar Mohamed Abdalla, El-Rehab (EG); Merfat Shaker Al-Sharif, Makkah (SA); Khalid Soliman Khairou, Makkah (SA)

(73) Assignee: UMM AL-QURA UNIVERSITY, Makkah (SA)

(21) Appl. No.: 14/186,189

(22) Filed: Feb. 21, 2014

(51) Int. Cl. B01J 23/50; B01J 37/10; B01J 35/02; B01J 37/00; B01J 35/10; B01J 37/04; B01J 37/06

(52) U.S. Cl. CPC B01J 23/50; B01J 37/04; B01J 37/10; B01J 37/06; B01J 37/009; B01J 35/1014; B01J 35/023

(57) ABSTRACT

Hybrid TiO₂ nanostructures with engineered morphologies (flakes, spheres and buds) supporting Ag nanocrystals were synthesized based on cooperative sol-gel chemistry of either titanium iso-propoxide or N-butoxide and assembled with polyvinyl alcohol and polyethylene glycol.

### FIELD OF THE INVENTION

This invention relates to a method for synthesizing silver nanoparticles on titania (TiO₂) and more particularly to a method that uses a template composed of polyvinyl alcohol and polyethylene glycol.

### BACKGROUND FOR THE INVENTION

A variety of approaches have been attempted to prepare Ag/TiO₂ supported nanoparticle catalysts, for example photodeposition, chemical deposition and conventional impregnation methods. In the earlier work, most of the Ag/TiO₂ nanocomposites were composed of randomly mixed TiO₂ and Ag nanoparticles. However, TiO₂ nanoparticles tend to agglomerate leading to a decrease in surface area and phase separation during repeated utilization. Moreover, if the Ag nanoparticles cannot be well dispersed on the surface of titania, the density of active sites on the Ag/TiO₂ surface will be incompetent. In addition, silver doped titania (Ag/TiO₂) nanocomposite structures have attracted attention because TiO₂ is a promising material with desirable electronic and optical properties and also because silver displays some unique activities in chemical and biological sensing compared with the other noble metals.

To date, it has been shown that either impregnation or photodeposition of noble metals with TiO₂ could effectively cause dramatic problems as for example low dispersion, low stability as well as particle size enlargement. Other methods involving sol-gel, “wet” chemical and ceramic methods where drying, heating or annealing at high temperatures are important steps in the preparation process are too complicated in the sense of revealing low silver dispersion. On the other hand, it has been acknowledged that the polyol process is a convenient, versatile and low-cost method for the synthesis of metal nanostructures.

In order to modify the TiO₂ by Ag nanoparticles, Applicants demonstrated that a one pot reaction using a combined template composed of polyvinyl alcohol and polyethylene glycol can be utilized for the in-situ Ag/titania nanoparticles preparation. The most relevant synthetic characteristic is the use of a hybrid polymer as template to produce mesoporosity in the material with tailorable morphology. The synthesized materials have been characterized by XRD, TEM, N₂ sorptiometry, FTIR and UV-Visible diffuse reflectance spectroscopy. The reduction of silver ions in Ag/TiO₂ is carried out during the reduction process of 4-nitrophenol; to its corresponding aminophenol by employing NaBH₄. The progress of the reduction reactions was followed by UV-vis spectrophotometer. The effects of catalyst and reduction agent amounts on the reduction of 4-nitrophenol were investigated at room temperature.

### BRIEF SUMMARY OF THE INVENTION

In essence the present invention contemplates a method for synthesizing nanoparticles on titania (TiO₂). The method comprises or consists of providing a mass of polyethylene glycol and a mass of polyvinyl alcohol dissolved in water in a ratio of about 7:3. The aforementioned compounds were thoroughly mixed with the water and silver nitrate (AgNO₃) at a ratio of between about 2% and about 6%. At this stage a material selected from the group consisting of titanium isopropoxide, titanium tetra-butoxide and mixtures thereof was added to produce a reaction mixture. The reaction mixture was placed in an autoclave and heated at a temperature of about 393° K for about 48 hours. Subsequently, the autoclaved and heated reaction mixture was centrifuged and the centrifuged hydrothermally treated reaction mix was washed three times with deionized water to produce a resultant product. Finally, the resultant product was dried for about eight hours and calcined in air for about six hours to produce silver nanoparticles on titania.

The invention will now be described in connection with the accompanying figures.

### DESCRIPTION OF THE DRAWINGS

FIG. 1 is an image of a transmission electron microscope image of a titanium ethylene glycol vinyl alcohol product;

FIG. 2 is an image from a transmission electron microscope of a TevAg₆ sample;

FIG. 3 is a graphical illustration of a change in the concentration of 4-NP with time in the reduction of 4-NP by Tev, Ttev, TevAg2, TtevAg2, TevAg6 and P25Ag4 in the presence of aqueous NaBH₄, reaction conditions: 100 ml [4NP]=1.8×10⁻⁴ mol L⁻¹, NaBH₄=2.0×10⁻¹, 750 rpm, temperature 298 K; and

FIG. 4 is a graphical illustration of a UV-vis absorption spectra for the reduction of 4-NP over TevAg₆ with an excess amount of NaBH₄ in aqueous media at 298K.

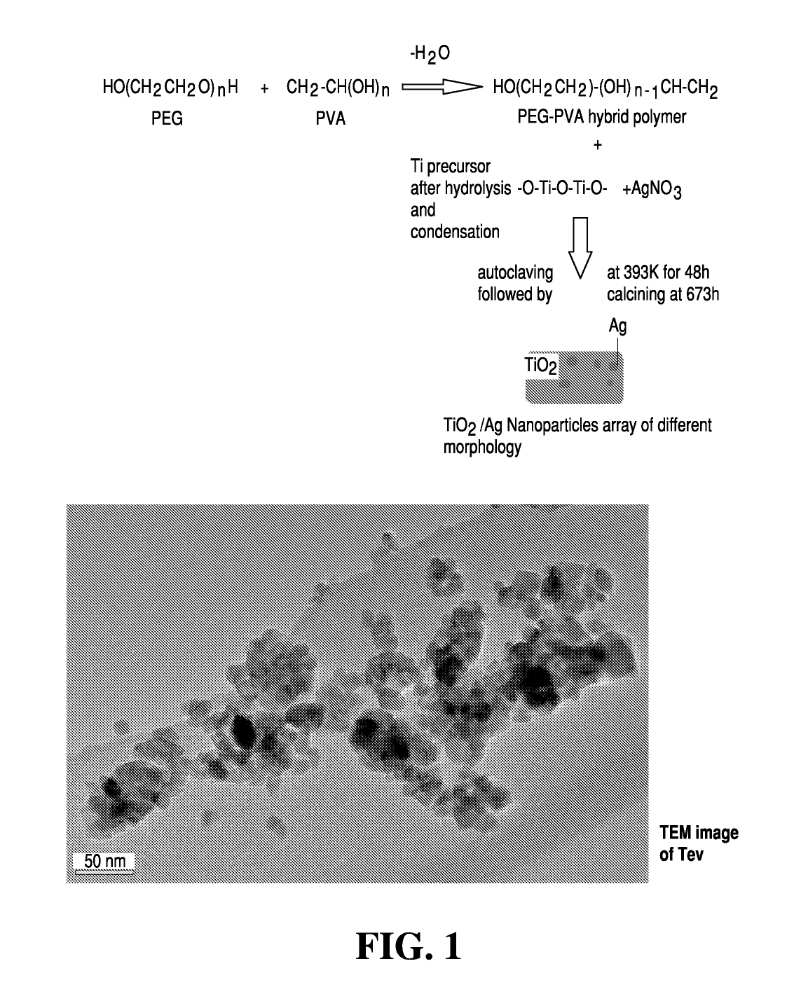

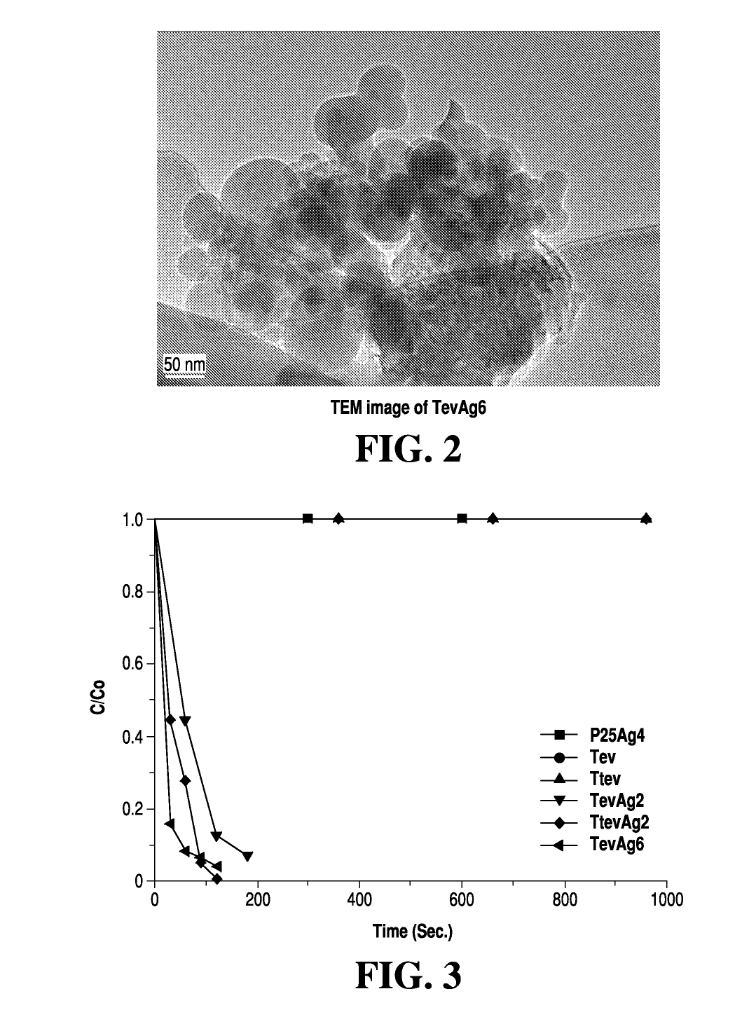

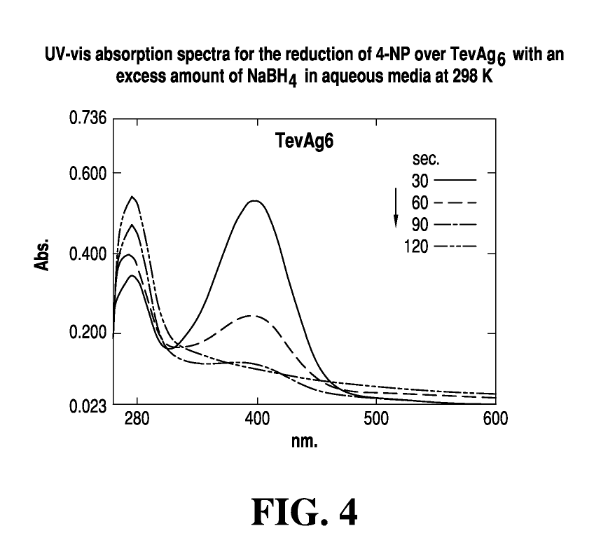

### DESCRIPTION OF THE PREFERRED EMBODIMENTS OF THE INVENTION

0.01 moles of polyethylene glycol (HO(CH₂CH₂O)ₙH) and 0.01 moles of polyvinyl-alcohol (CH₂—CH(OH)ₙ) are dissolved in a least amount of water (15 ml) in a weight ratio of 7:3. The materials were mixed thoroughly. Titanium iso-propoxide (Ti(OCH(CH₃)₂)₄) was added into the above mixture in a drop wise manner with vigorous stirring for half an hour at room temperature. The resulting reaction mixture was transformed into an autoclave lined with Teflon followed by hydrothermal treatment at 393 K for 48 h.

After hydrothermal treatment, the product was recovered by centrifuging at about 750 rpm for about 30 minutes and then washed 3 times with deionized water. The solid was then dried overnight at 333 K and further calcined in air at 673 K for 6 h to remove the copolymer template. This sample was denoted as Tev, where the letter T stands for Titania, the letter e expresses polyethylene glycol and v expresses polyvinyl-alcohol. Different weight % were prepared in Ag/TiO₂ ratios at which the AgNO₃ insertion took place at a ratio of either 2% or 6% in a solution form before titanium iso-propoxide admission took place to prepare samples denoted as TevAg₂ and TevAg₆. In the same way titanium tetra-butoxide (Ti(O(CH₂)₃CH₃)₄-30 ml) was used instead of titanium isopropoxide to synthesize samples denoted as Ttev; where t represents titanium tetra-butoxide, and TtevAg₂ signifies the sample with silver insertion ratio of 2%. Scheme 1 shows the generation of self-assembled hybrid arrays of Ag/TiO₂ using polyethylene glycol and polyvinyl alcohol templates. TiO₂ P25 (70% anatase:30% rutile) with a surface area of 49 m² g⁻¹ and primary crystal size 30 nm that was purchased from Degussa was impregnated with AgNO₃ at a ratio of 4% by dispersing TiO₂ powder in 30 ml ethanol followed by addition of AgNO₃ solution to give a catalyst denoted as P₂₅Ag₄, for comparison purposes. Different patches were synthesized for the Ag/TiO₂ catalysts following the same procedure and as a result a good reproducibility has been attained.

In the case of TevAg₆ and TtevAg₂, most of AgNPs (nanoparticles) were well scattered on the entire surfaces of TiO₂ supports in the form of Ag₂O/Ag° species rather than highly dispersed Ag° nanoparticles as in TevAg₂ catalyst. Thus, such a unique surface distribution of Ag moieties could possibly contribute to efficient accessibility of the reactants to the catalytic active sites, resulting in excellent catalytic performances for TevAg₆ and TtevAg₂. When the reactions were conducted without stiffing the TevAg₆ catalyst showed a much higher catalytic performance than the TevAg₂ catalyst, indicating the effective transport of the 4-NP (nanoparticles) to the Ag surfaces, even under static conditions.

From these results, it can be suggested that the combination of a unique mesostructure, with an open porous nature, and the opportunity for Ag₂O/AgNPs to be exposed to the reactants, contribute to the efficient transport of the 4-NP to the Ag surfaces, leading to an excellent catalytic activity for TevAg₆ and TtevAg₂ catalysts. Changes of morphology from spherical structure in TevAg₂ into bud ones with residual circular shape in TevAg₆ might also affect on the activity towards 4-NP reduction. However, in this specific case a direct correlation between the activity and shape of the catalyst cannot be fully achieved although the presence of the bud shape affects the activity when it presents in a proportion to the circular ones.

Additionally, the activation energy parameter at different temperatures for 4-NP reduction on TevAg₆ was calculated from 1 n k−1/T equation. The activation energy for the reduction of 4-NP was 39.69 kJ mol⁻¹. The obtained activation energy was lower than other catalysts used to activate the same reaction such as Au/MAP (47 kJ mol⁻¹), silver nanoshell-coated cationic polystyrene beads (51 kJ mol⁻¹) and Au/polyelectrolyte brushes (43 kJ mol⁻¹). Normally, a reaction that is controlled by external mass transport (either gas—liquid or liquid—solid mass transport) has activation energy of less than 25 kJ/mol. Therefore, these high values of observed activation energies suggest that the influence of liquid—solid mass transport was negligible in this study. It appears also that the presence of appreciable amount of rutile percentages comprised of 24% in TtevAg₂ could also share in increasing the activity comparatively. This is because of the possibility of forming many hetero-junctions such as anatase/rutile, Ag/anatase and Ag/rutile on which H can move to improve the activity towards the reduction process. In addition, the presence of residual C—O species on the TtevAg₂ catalyst as a result of the non-complete decomposition of the template can share in the oxidation of Ag° into Ag⁺ with subsequent reduction of Ag⁺ by BH₄⁻ considering that the in situ reduction of Ag⁺ is very important to this reduction reaction.

A facile hydrothermal one pot method for synthesizing Ag/TiO₂ nanoparticles via employing either iso-propoxide or tetrabutyl as a titanium precursor and polyvinyl alcohol and polyethylene glycol as hybrid template was depicted. A marked higher reduction rate of 4-NP to 4-AP was achieved on TevAg₆ and Ttevag₂ catalysts in 2 minutes reaction time with 100% conversion and they show significant stability upon reusability. This excellent performance of the mentioned catalysts was attributed to the following aspects: (1) the presence of exposed Ag₂O species beside dispersed Ag nanoparticles on the surface of TiO₂ nano-buds (nano-circular) result in a higher catalytic reduction of 4-NP; (2) the mesoporous architecture and surface texturing properties specifically S_{BET} and pore volume contributes well to increasing the activity through facilitating both adsorption and diffusion processes; (3) Ag nanoparticles of medium sizes comprised of 15-20 nm facilitate the adsorption of BH₄⁻ besides phenolate ions rather than smaller ones (2 nm) leading to an enhanced catalytic activity.

Further details related to the above-identified invention can be found in an article by Mohamed Mokhtar Mohamed et al. entitled “One pot synthesis of silver nanoparticles supported on TiO2 using hybrid polymers as template and its efficient catalysis for the reduction of 4-nitrophenol,” Materials Chemistry and Physics, Vol. 136, pp. 528-537 (2012), http://dx.doi.org/10.1016/J.matchemphys.2012.07021.

The results obtained confirmed for the first time the potential of the one pot method in synthesizing Ag/TiO₂ nanoparticles via hybrid templates and their high efficacy in catalyzing the reduction of 4-nitrophenol into 4-aminphenol; via NaBH₄, accomplishing 100% conversion in 2 min reaction time. The TevAg6 catalyst; derived from isopropoxide, of bud shape and particle sizes of 20 nm showed a comparable activity to that of TtevAg2 and exhibited a rate constant of 6.9×10⁻³ s⁻¹ resembling that of 7.2×10⁻³ s⁻¹ for TtevAg2. No deactivation for the catalysts was observed after repeated recycling.

While the invention has been described in connection with its preferred embodiments, it should be recognized that changes and modifications may be made therein without departing from the scope of the appended claims.

What is claimed is:

1. A method for synthesizing silver nanoparticles on titania (TiO₂) comprising:
providing a mass of polyethylene glycol and a mass of polyvinyl alcohol dissolved in water in a weight ratio of about 7:3;
thoroughly mixing the polyethylene glycol and the polyvinyl alcohol in water;
adding silver nitrate (AgNO₃) at a ratio of between about 2% and about 6%;
adding a material selected from the group consisting of titanium isopropoxide, titanium tetra-butoxide and mixtures thereof to produce a reaction mixture;
placing the reaction mixture in an autoclave and heating at a temperature at about 393° K for about 48 hours;
centrifuging the hydrothermal treated reaction mix and washing the centrifuged product three times with deionized water to produce a resulting product; and
drying the resulting product for about eight hours and calcining the product in air for about six hours to product silver nanoparticles on titania.

2. The method for synthesizing silver nanoparticles on titania according to claim 1 in which 0.01M of polyethylene glycol and 0.01M of polyvinyl alcohol are dissolved in a minimum amount of about 15 ml of water.

3. The method for synthesizing silver nanoparticles on titania according to claim 2 in which the material added to the polyethylene glycol, polyvinyl alcohol and water is titanium isopropoxide.

4. The method for synthesizing silver nanoparticles on titania according to claim 2 in which the material added to the polyethylene glycol, polyvinyl alcohol and water is titanium tetra-butoxide.

5. The method for synthesizing silver nanoparticles on titania according to claim 3 in which 29.3 ml of titanium isopropoxide is added to the reaction mixture.

6. The method for synthesizing silver nanoparticles on titania according to claim 4 in which 30 ml of titanium tetra-butoxide is added to produce the reaction mixture.

7. The method for synthesizing silver nanoparticles on titania according to claim 2 in which the reaction mixture was placed in an autoclave lined with Teflon (polytetra/fluoroethylene) followed by a hydrothermal treatment at 393° K for about 48 hours.

8. The method for synthesizing silver nanoparticles on titania according to claim 7 in which the hydrothermally treated reaction mix is centrifuged at about 750 rpm for about 30 minutes to produce a centrifuged product.

9. The method for synthesizing silver nanoparticles on titania according to claim 8 in which the centrifuged and washed product is dried at about 333° K and calcined in air at about 673° K to remove the polyethylene, polyvinyl alcohol template.

10. The method for synthesizing silver nanoparticles on titania according to claim 9 in which the Ag/TiO₂ is 70% anatase: 30% rutile with a surface area of about 49 m²g⁻¹ and primary crystal size is 30 mm.

11. The method for synthesizing silver nanoparticles on titania according to claim 10 in which the polyethylene glycol and polyvinyl alcohol templates are impregnated with a silver insertion rate of 2%.

12. The method for synthesizing silver nanoparticles on titania according to claim 11 in which the polyethylene glycol and polyvinyl alcohol templates are impregnated with a silver insertion rate of 4%.

13. The method for synthesizing silver nanoparticles on titania according to claim 12 in which the polyethylene glycol and polyvinyl alcohol templates are impregnated with a silver insertion rate of 6%.

14. A method for synthesizing silver nanoparticles on titania (TiO₂), said method consisting of:
providing a mass of 0.01M of polyethylene glycol (HO(CH₂CHO)ₙH) and a mass of 0.01M of polyvinyl alcohol (CH₂—CH(OH)ₙ) dissolved in 15 ml of water and wherein the weight ratio is 7:3;
thoroughly mixing the mass of polyethylene glycol and the polyvinyl alcohol in water;
adding silver nitrate (AgNO₃) at a ratio of between about 2% and about 6%;
adding 29.3 ml of titanium isopropoxide (Ti(OCH(CH₃)₂)₄) in a dropwise manner with vigorous stirring over 30 minutes at room temperature to produce a reaction mixture;
transforming the reaction mixture into an autoclave and subjecting the reaction mixture to a hydrothermal treatment at about 393° K for about 48 hours;
centrifuging the hydrothermal treated reaction mixture at about 750 rpm for about 30 minutes to produce a centrifuged product and washing the centrifuged product three times with deionized water to produce a resulting product; and
drying the resulting product for about eight hours at about 333° K and further calcining the dried product in air at about 673° K for about six hours.

15. A method for synthesizing silver nanoparticles on titania (TiO₂), said method consisting of:
providing a mass of 0.01M of polyethylene glycol (HO(CH₂CHO)ₙH) and a mass of 0.01M of polyvinyl alcohol (CH₂—CH(OH)ₙ) dissolved in 15 ml of water and wherein the weight ratio is 7:3;
thoroughly mixing the mass of polyethylene glycol and the polyvinyl alcohol in water;
adding silver nitrate (AgNO₃) at a ratio of between about 2% and about 6%;
adding about 30 ml of titanium tetra-butoxide (Ti(O(CH₂)₃)₄) in a dropwise manner with vigorous stirring over 30 minutes at room temperature to produce a reaction mixture;
transforming the reaction mixture into an autoclave and subjecting the reaction mixture to a hydrothermal treatment at about 393° K for about 48 hours;
centrifuging the hydrothermal treated reaction mixture at about 750 rpm for about 30 minutes to produce a centrifuged product and washing the centrifuged product three times with deionized water to produce a resulting product; and
drying the resulting product for about eight hours at about 333° K and further calcining the dried product in air at about 673° K for about six hours.
